(19) United States
(12) Patent Application Publication
(10) Pub. No.: US 2009/0278066 A1
(43) Pub. Date: Nov. 12, 2009

(54) HYDRAULIC VALVE CONTROL DEVICE AND METHOD FOR CHECKING A HYDRAULIC VALVE CONTROL DEVICE

(75) Inventor: Dieter Keller, Veitshoechheim (DE)

Correspondence Address: DARBY & DARBY P.C., P.O. BOX 770, Church Street Station, New York, NY, 10008-0770, US

(73) Assignee: Robert Bosch GmbH, Stuttgart (DE)

(21) Appl. No.: 12/436,238

(22) Filed: May 6, 2009

(30) Foreign Application Priority Data
May 10, 2008 (DE) 10 2008 023 198.3

(51) Int. Cl. F16K 31/02; G05F 1/10

(52) U.S. Cl. 251/129.01; 323/271

(57) ABSTRACT

A hydraulic valve control device for a hydraulic valve containing at least one actuator, the hydraulic valve control device comprises a first voltage supply input, an output stage configured to output a drive current for driving the actuator, wherein the output stage has a second voltage supply input, a first switch disposed between the first voltage supply input and the second voltage supply input, an enable input configured to switch the output stage between an on position and an off position, a switch-off device configured to open the first switch when the output stage is in the off position, and a checking circuit configured to check a function of the first switch when the output stage is in the on position.

Priority is claimed to German Patent Application No. DE 10 2008 023 198.3, filed on May 10, 2008, the entire disclosure of which is incorporated by reference herein.

The invention relates to a hydraulic valve control device and to a method to actuate a hydraulic valve control device.

### BACKGROUND

When it comes to hydraulic valves, especially hydraulic valves used in driven machines, safety precautions have to be taken so that the hydraulic valves do not trigger movements that pose a hazard to the environment. For this reason, particularly in the case of hydraulic valves that have solenoids to move a valve spool, care is taken to reliably ensure that the solenoids cannot be inadvertently energized.

The solenoids are driven by output stages that are powered by a voltage supply. In addition to the switch-off function of the output stages, which switch their outputs high-ohmically during the switching-off, as a safety measure, it should be possible to disconnect the output stage from the supply voltage by means of a switch.

Data sheet RD 95200 of the Bosch Rexroth company dated November 2007 shows a control device for a hydraulic valve having a central safety shutdown. Here, however, the problem arises that the components employed for the safety shutdown are likewise subjected to ageing processes, and a failure of the central safety shutdown can give rise to undesired reactions in the system that is actuated by the hydraulic valve.

### SUMMARY OF THE INVENTION

An aspect of the present invention is to provide a hydraulic valve control devices in which a higher level of safety can be ensured for switching off the output stages of the control device and a method for checking such a hydraulic valve control device.

A hydraulic valve control device for a hydraulic valve that contains an actuator is provided. The hydraulic valve control device has a first voltage supply input and an output stage for outputting a drive current for the actuator of the hydraulic valve. The output stage has a first voltage supply input. A first switch is provided between the first voltage supply input of the output stage and the first voltage supply input of the hydraulic valve control device.

The hydraulic control device also has an enable input for switching the output stage on and off. Moreover, there is also a switch-off device for opening the first switch when the output stage is switched off by the enable input. A checking circuit is provided for checking the function of the first switch when the output stage is switched on. During operation, the first switch is often switched on for long periods of time without interruption. As a result, whether its function has been detrimentally affected by ageing or external malfunctions is noticed very late or not at all. The checking circuit allows the error to be recognized in time so that a user or a superordinated system can respond to this situation.

In one embodiment, the checking circuit is provided for briefly opening the first switch when the output stage is switched on. The term “briefly” means that the checking circuit does not open the first switch all the time when the output stage is enabled, but rather, only for a limited period of time. Moreover, the hydraulic valve control device comprises a measuring circuit to detect whether the first checking circuit has opened the first switch.

In the simulation of the circuit in a given embodiment, it has been found that the time t during which the checking circuit opens the first switch is suitably set at t<1 millisecond. For example, the selection is made for t=0.3 ms, whereby it should be noted that, due to the inertia of the switching procedure, the drive pulse for the switch is longer than t. The drive pulse was 0.6 ms in the simulated embodiment.

With the hydraulic valve control device being provided here, it can be regularly checked during the enabling of the output stage whether the first switch in fact opens when it its appropriately actuated. This raises the safety so that the opening still functions even when the output stage is no longer enabled and has to be disconnected from the voltage supply. This ensures that, when the output stage is switched off, current can no longer flow through the actuator of the hydraulic valve and the actuator no longer triggers any undesired movements of the valve spool.

If the first switch or its actuation becomes defective, for example, due to ageing processes, this is detected by means of the measuring circuit before this defect can cause an error in the actuation of the hydraulic valve. Therefore, the control device can be repaired in time or else a possible actuation error can be prevented in a different manner.

Preferably, the hydraulic valve control device is integrated into a housing together with the hydraulic valve that is actuated by the hydraulic valve control device. This not only reduces the space requirements for the entire system but also decreases the complexity for users since the connection between the control device and the valve already exists and the risk of polarity reversal drops.

In one embodiment, an uncoupling device is provided for uncoupling the first switch from the first voltage supply input of the output stage when the first switch is open. In this manner, the measuring circuit can check, irrespective of the load, whether the first switch is indeed open.

If, for example, a high inductive or capacitive load at the voltage supply input of the output stage is acting on the first switch, it becomes more difficult for the measuring circuit to distinguish whether, for instance, changes in the potential at the terminals of the first switch are due to the opening of the first switch or due to changes in the load. The uncoupling ensures that only the opening of the first switch has an effect on the measured value. This also allows the speed of the measuring procedure to be increased, so that the duration of the brief opening of the first switch can be shortened.

If the uncoupling device contains a diode, the latter does not have to be actively connected, which reduces the complexity of the circuit and increases the sturdiness of the circuit.

Preferably, the measuring circuit has an output that serves to output an error and that is connected to the output of the hydraulic valve control device. This allows an error to be displayed to the system that is superordinated to the control device so that the system can respond appropriately.

In one embodiment, another switch, a so-called redundancy switch, is connected in series to the first switch in the path between the voltage supply input of the output stage and the voltage supply input of the hydraulic valve control device. Furthermore, a safety shutdown serves to open the redundancy switch in case the checking circuit has not opened the first switch. In this manner, it is ensured that an error inside the control device is remedied and that the control device is set in a safe state. If the first switch or its actuation is defective, the redundancy switch can take over the disconnection of the output stage from the voltage supply.

As an additional circuit, a second checking circuit can be provided for regularly opening the redundancy switch when the output stage is switched on. A second measuring circuit is configured for checking whether the second checking circuit has opened the redundancy switch. In this manner, the redundancy switch is also checked when the output stage is switched on, so that defects in the redundancy switch can also be detected in time.

Preferably, another switch-off device is provided which opens the first switch if the second check circuit has not switched off the redundancy switch. In this manner, the first switch is opened and thus the voltage supply for the output stage is interrupted if the redundancy switch is defective.

In a preferred embodiment, a capacitor is provided for stabilizing the voltage at the voltage supply input of the output stage. The capacitor ensures the supply of the output stage with current during the brief periods of time during which the first switch or the redundancy switch are being checked.

In one embodiment, the measuring circuit has a resistor between a first terminal of the first switch and a node having a fixed potential. The resistor ensures that the voltage at the first terminal drops when the first switch is opened. This voltage change can then be measured. In one embodiment, the resistor is implemented as an ohmic resistor. In another embodiment, it is implemented as a load path of a transistor, as a result of which the speed of the discharge can be reduced.

Preferably, the first switch comprises a power transistor. In comparison to relays, power transistors take up less space when they are accommodated in the housing of the control device.

A method for checking the switch-off function of a hydraulic valve control device is also being put forward in which a hydraulic valve control device according to the invention is provided. The actuators of the valve are supplied with current by the output stage and the first switch is actuated at regular intervals in such a manner that it briefly opens. In this case, the voltage is measured at the output of the first switch. This voltage measurement detects whether the switching-off of the first switch is functioning error-free.

### BRIEF DESCRIPTION OF THE DRAWINGS

Embodiments of the invention will be explained in greater detail below making reference to the figures.

FIG. 1 shows the structure of a hydraulic valve control device according to the invention, with a hydraulic cylinder connected thereto;

FIG. 2 shows the details of the control device from FIG. 1;

FIG. 3 shows additional details of the control device from FIG. 2;

FIG. 4 shows a block diagram of the monitoring functions of another embodiment of a hydraulic valve control device;

FIG. 5 shows circuits for implementing the monitoring function according to FIG. 4.

### DETAILED DESCRIPTION

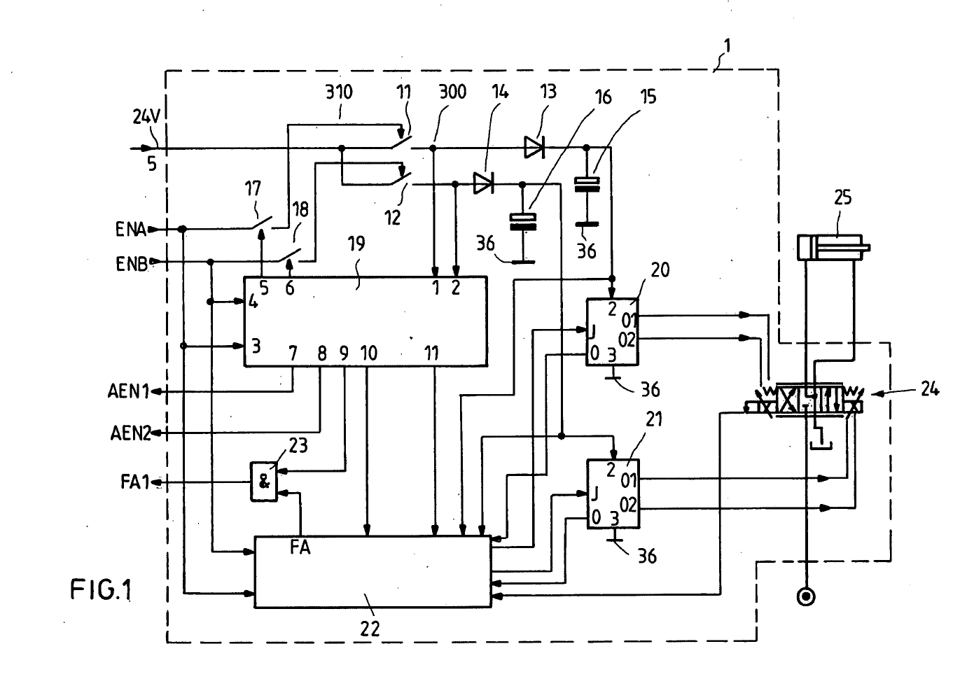

FIG. 1 schematically shows the structure of a hydraulic valve control device 1 according to the invention, with an integrated hydraulic valve 24. The term “integrated” means that the hydraulic valve 24 and the valve electronics for actuating the hydraulic valve 24 are accommodated together in a housing.

The hydraulic valve 24 serves to drive a hydraulic cylinder 25 located outside of the housing. The hydraulic valve is configured as a proportional valve in which a magnetic field is generated by means of coils. The magnetic field moves a spool in the valve as a function of the current passing through the coils. Other versions are likewise possible in which other actuators driven by electric current are employed instead of the coils.

The hydraulic valve control device 1 comprises a first output stage 20, a second output stage 21 as well as an output stage actuating device 22. The output stages 20 and 21 each have an input I, two outputs O1 and O2, a feedback output O, a first voltage supply input 2 and a second voltage supply input 3.

The hydraulic valve control device 1 also has the two enable inputs ENA and ENB. A system that is superordinated to the hydraulic valve control device 1 applies a level to these inputs that determines whether the output stages 20 and 21 allow current to flow through the solenoids of the hydraulic valve or whether they switch their outputs O1 and O2 high-ohmically. If a high level is applied to the enable inputs ENA and ENB of the hydraulic valve control device, the output stage actuating device 22 emits pulse-width-modulated signals at the output stages 20 and 21 so that current flows through the solenoids of the hydraulic valve 24.

If low levels are applied to the enable inputs ENA and ENB, the outputs O1 and O2 are switched high-ohmically and additionally the output stages 20 and 21 are disconnected from their voltage supply.

The output stages 20 and 21 each receive at their inputs I a signal that determines how much current passes through the solenoids of the hydraulic valve 24. This current flows from the first voltage supply input 2 through a driver in the output stage 20 via the output O1, via a solenoid of the hydraulic valve 24 to the output O2 through another driver in the output stage and from there, to the second voltage supply input 3 that is connected to the ground 36.

The input I of the output stage 20 or of the output stage 21 is actuated by the output stage actuating device 22 that is contained, for example, in a microcontrol device. In a common embodiment, the output stages 20 and 21 each contain full bridges and their inputs I are actuated by pulse-width-modulated signals. A value for the current that flows through the output stage is output at the feedback output O of the output stages 20 and 21. For this purpose, in one embodiment, a measuring resistor is provided in each of the output stages 20 and 21. The voltage that is present via this measuring resistor is output at the feedback output O to the output stage actuating device 22. The output stage actuating device 22 regulates the position of the hydraulic valve 24 in that it receives the position of the valve spool via a feedback path from the hydraulic valve 24 to the output stage actuating device 22.

Therefore, the actuation of the output stage 20 and the position regulation of the proportional valve are done by means of a microcontrol device in the output stage actuating device 22. In this embodiment, this microcontrol device also takes over the actual regulation of the current of the output stages.

Errors in the regulation are also detected in the output stage actuating device 22 and, in case of an error, the output stage actuating device 22 outputs a zero at its output FA. For purposes of checking the switch-off function of the output stages 20 and 21, if necessary, the microcontrol device can de-energize the output stages 20 and 21 and can then carry out a comparison between the target value and the actual value to check whether the proportional valve 24 is in the expected safe position. Normally, in applications where there is a need for the drive to be firmly secured, a valve having a positively overlapping piston is employed. Once the supply voltage of the output stages is switched back, the valve mechanism locks the piston in this zero position, which is checked in the manner described above.

The hydraulic valve control device 1 according to the invention is provided with an additional internal circuit that additionally disconnects the supply voltage from the appertaining output stage and subsequently checks whether the voltage generated in this process is actually at an uncritical level.

Towards this end, the first output stage 20 is provided with a first switch 11, a first diode 13, a first capacitor 15 as well as a third switch 17. The first switch 11 is provided between the voltage supply input 5 and the anode of the first diode 13. A direct voltage 24 V that also supplies the power source of the device is applied to the voltage supply input 5 of the hydraulic valve control device. The node to which the anode of the first diode 13 is connected is designated as node 300. The connection line that leads to the actuator input of the first switch 11 is designated by the reference numeral 310.

The cathode of the first diode 13 is connected to the first voltage supply input 2 of the first output stage 20. Thus, in the closed state, the first switch 11 couples the first voltage supply input 2 of the first output stage 20 to the voltage supply input 5 of the hydraulic valve control device 1, so that the current can flow from the voltage supply input 5 to the first output stage 20. Between the cathode of the first diode 13, the first plate of a first capacitor 15 is connected whose second plate is connected to the ground 36.

The third switch 17 is closed most of the time, so that, when the first output stage 20 is enabled by applying a high level to the enable input ENA, the first switch 11 is likewise closed at first. If a low level is then applied to the enable input ENA from the outside, the output stage actuating device 22 actuates the first output stage 20 in such a way that no more current flows into the solenoid of the hydraulic valve 24. At the same time, the first switch 11 is actuated in such a manner that it opens and thus disconnects the first voltage supply input 2 of the output stage 20 from the voltage supply input 5 of the hydraulic valve control device 1.

The anode of the diode 13 is also connected to the input 1 of the monitoring block 19. If the enable input ENA is at the low level, then the monitoring block 19 checks whether the switch 11 is open. Inside the monitoring block 19, a resistor R1 is positioned between the input 1 and the ground 36. When the switch 11 is open, the resistor R1 ensures that the potential that is present at the anode of the first diode 13 is grounded or near the ground. The monitoring block 19 then checks whether the resistor R1 has actually lowered the potential at the input 1. If this is not the case, it is concluded that the switch 11 is not open and that an error has occurred. This error is indicated by outputting a low level at the output 9 of the monitoring block 19.

The monitoring block 19 can be implemented as an analog circuit, as a digital circuit or as a microcontrol device. Once the switch 11 has opened, the monitoring block 19 issues an enabling acknowledgment at its output 7 which is output at an output of the hydraulic valve control device 1 as an acknowledgment signal AENA. In this embodiment, the output signals AENA and AENB report to the superordinated control device whether an enablement is present, and furthermore the output stage in question is de-energized. Moreover, the switching-off that has taken place is also reported to the output stage actuating device 22 via the output 10 of the monitoring block 19.

Analogously to the circuit of the supply voltage for the first output stage 20, a circuit to couple the first voltage supply input 2 to the voltage supply input 5 of the hydraulic valve control device 1 is likewise provided for the second output stage 21. A second switch 12 is connected between the voltage supply input 5 and the anode of a second diode 14. The cathode of the second diode 14 is connected to the first voltage supply input 2 of the second output stage 21.

Moreover, a second capacitor 16 is provided whose first plate is connected to the cathode of the second diode 14 and whose second plate is connected to the ground 36. A fourth switch 18 is provided between the enable input ENB and the control input of the second switch 12. The interruption of the voltage supply for the second output stage 21 takes place like the interruption of the voltage supply for the first output stage 20 and consequently does not need to be repeated here.

The first switch 11 and the second switch 12 are preferably configured as power transistors or as power MOSFETs.

An error is output at the output FA1 of the hydraulic valve control device 1 if an error is indicated by the monitoring block 19 or by the control circuit 22. The error output is indicated by a low level at the error output FA1.

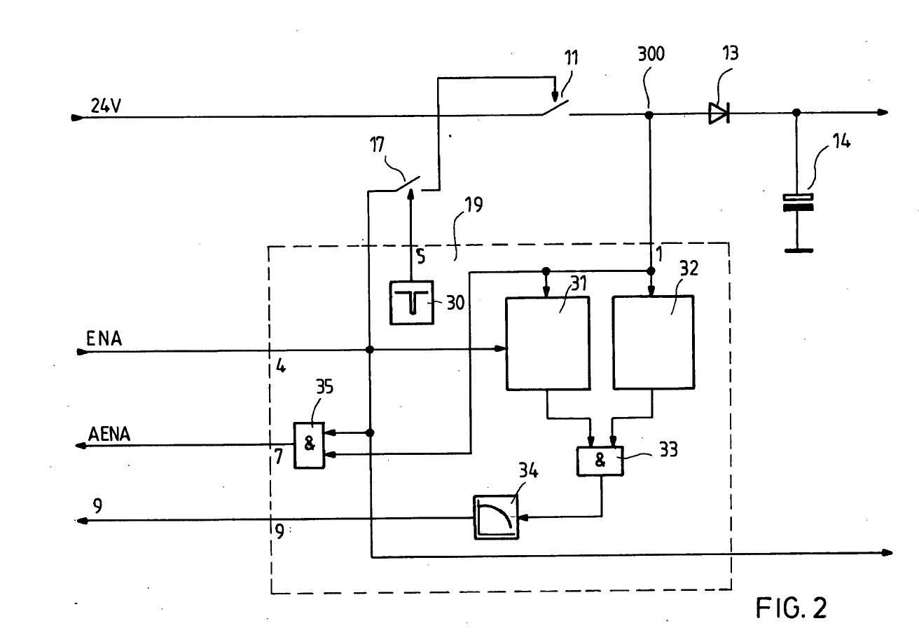

FIG. 2 shows details of the monitoring block 19 of the hydraulic valve control device 1 according to FIG. 1. Elements having the same function as in the preceding figures are designated with the same reference numerals and will not be elaborated upon anew. The monitoring block 19 has an oscillator 30, a static evaluation unit 31, a dynamic evaluation unit 32, a first AND gate 33, a low-pass 34 as well as a second AND gate 35.

At the output 5 of the monitoring block 19, the oscillator 30 generates a periodical signal that, most of the time, is at the high level and only for brief periods of time, for instance, one millisecond, at the low level. The third switch 17 is closed during the high level, in contrast to which the third switch 17 is open during the low level. When the switch 17 is closed, the enable signal ENA is connected to the switching input of the first switch 11. In this context, if the enable signal ENA is at zero, the switch 11 is opened, so that the voltage supply for the first output stage 20 is interrupted.

The static evaluation unit 31 receives the signal at the input 1 of the monitoring block 19 as well as the signal ENA as input signals. The dynamic evaluation unit 32 receives only the signal at the input 1 of the monitoring block 19. At its two inputs, the first AND gate 33 receives the output signals of the static monitoring unit 31 and of the dynamic monitoring unit 32. The output of the first AND gate 33 is connected to the input of the low-pass 34 which, in turn, drives the output 9 of the monitoring circuit 19. At its two inputs, the second AND gate 35 receives the enable signal ENA and the signal at the input 1 of the monitoring block 19. The second AND gate 35 outputs the signal for the enable acknowledgment AENA at the output 7.

If the enable signal ENA and the signal at the input 1 of the monitoring circuit 19 are both at logic one, that is to say, at the high level, then the hydraulic valve control device 1 has received the enable signal ENA and the switch 11 is closed. In this case, the enable acknowledgment signal AENA is output to the superordinated actuation unit of the hydraulic valve control device 1.

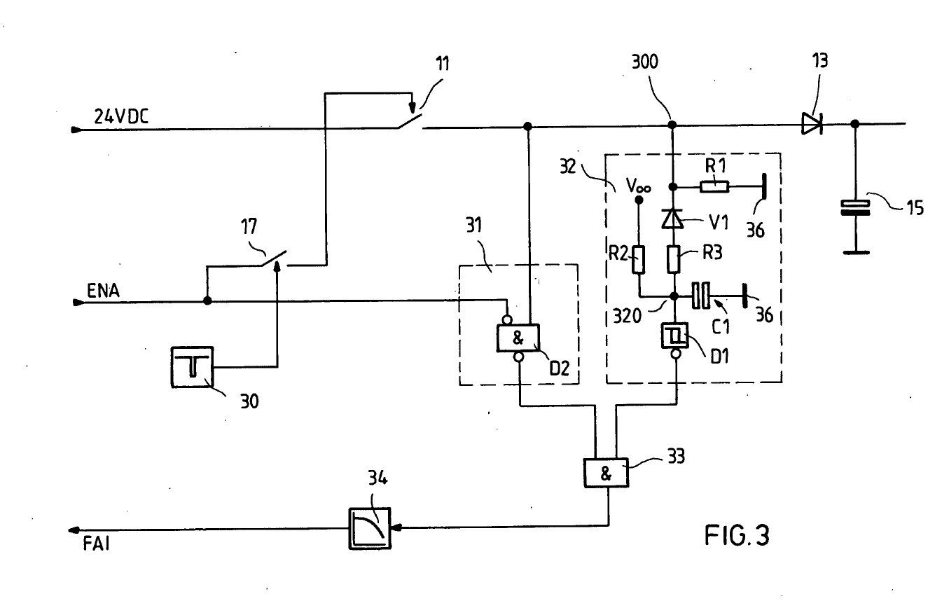

FIG. 3 shows an embodiment of an implementation of the static evaluation unit 31 and of the dynamic evaluation unit 32. The static evaluation unit 31 has a NAND gate D2 with an inverting input and a non-inverting input. The static evaluation unit 31 checks the state of the first switch 11 in case the output stage is not enabled. If the enable signal ENA is at the low level, the switch 11 should be open. In this process, the voltage at the node 300 is lowered because current is flowing through the resistor R1 of the dynamic evaluation unit 32 to the ground. A charge is still stored in the capacitor 15, so that the voltage at the cathode of the first diode 13 only drops by a few volts, for example, 2 V. However, the p-n junction of the first diode 13 prevents a charge from flowing from the first plate of the first capacitor 15 to the anode of the first diode 13.

If the first switch 11 has opened error-free, the potential at the node 300 is close to the ground potential. In case of an error, in contrast, a high level is still driven since the first switch 11 has not opened correctly. In this case, a low level is output at the output of the NAND gate D2 and thus an error is indicated.

The dynamic evaluation unit 32 has a first resistor R1, a second resistor R2, a third resistor R3, a capacitor C1, a diode V1 as well as a threshold value detector D1. The first resistor R1 is provided between the node 300 and the ground 36. The cathode of the diode D1 is likewise connected to the node 300, whereas its anode is connected to a first terminal of the third resistor R3. The second terminal of the third resistor R3 is connected to a node 320 that is connected to the input of the threshold value detector D1. The second resistor R2 is located between a voltage supply source V_{DD} and the node 320. The first plate of the capacitor C1 is connected to the node 320 and its second plate is connected to the ground 36.

The dynamic evaluation unit 32 functions in conjunction with the oscillator 30. At its output, the oscillator 30 cyclically—for example, once per second—emits a low pulse of, for instance, one millisecond, each time for a short period of time. When the output stage has been enabled by the signal ENA, the first switch 11 is also opened for this short pulse.

When the first switch 11 opens, the potential at the node 300 drops because of the current through the resistor R1 in the direction of the ground. As a result, the potential at the node 320 also drops since current likewise flows through the resistor R3, through the diode V1 and through the resistor R1 in the direction of the ground. The capacitor C1 is discharged in this process. For this purpose, the ratio of the third resistance R3 to the sum of the resistances R1 and R2 is selected so as to be sufficiently large so that the potential of the node 320 is as close as possible to the ground potential after the capacitor has discharged.

Once the first switch 11 has once again been closed, owing to the polarity of the diode D1, no more current flows between the nodes 300 and 320. Rather, the capacitor C1 is drawn via the resistor R2 in the direction of the potential VDD that is, for example, at 5 V.

As soon as the potential at the node 320 has reached about 2 V, the oscillator 30 emits its next low pulse, so that the capacitor C1 is discharged once again. As long as the pulses from the oscillator 30 are regularly triggered, the potential at the node 320 does not rise above a certain threshold value.

If no more pulse is being output by the oscillator 30 or if the first switch 11 no longer opens during the pulses, then the capacitor C1 is no longer discharged. If the threshold value of, for example, 3 V at the node 320 is exceeded, the threshold value detector D1 emits a low level at its output, thus indicating the occurrence of an error.

The first diode 13 serves to uncouple the output stage 20 from the first switch when the first switch 11 is open. In this manner, the node 300 is discharged quickly and independently of the load on the node that is connected to the first voltage supply input 2 of the output stage 20. Thus, the first resistor R1 can be dimensioned independently of this load. Moreover, the time needed for the discharge is reduced so that the pulse duration of the low pulse of the oscillation 30 can also be shortened. Instead of the first diode 13, it is also possible, for example, to provide a transistor that is also opened when the first switch 11 opens, in order to uncouple the output stage from the node 300.

The low pulses emitted by the oscillator 30 should be so short that the function of the output stage 20 is not detrimentally affected. Due to the charge stored in the first capacitor 15, the potential at the cathode of the first diode drops. In one embodiment, the first capacitor 15 has such a large capacitance that the voltage only drops by a few volts, even when a current of 3 A is flowing through the output stage 20. Consequently, an electrolyte capacitor is preferably employed as the first capacitor 15.

In another embodiment, a first capacitor 15 is provided with a small capacitance. If the pulses last, for instance, only one millisecond, then, even in the case of a large voltage drop due to the inertia of the valve, the position error will be so small that it is hardly noticeable in the application and besides, it can also be corrected without any difficulty.

At its output, the first AND gate 33 emits a low level if one or both of the evaluation units 31 and 32 output or emit a low level.

The error output FA1 is connected here in the form of a low-active sum error output. Errors are output at the output FA1 by the output of a low level to the circuit that is superordinated to the hydraulic valve control device 1. The low pass 34 filters out high-frequency interference pulses.

FIG. 3 schematically shows both evaluation units 31 and 32 with components. Level adaptations that might be necessary are not shown. Instead of the resistor R1, it is also possible to employ an active component, for instance, a transistor or the like, that ensures an even faster drop in the voltage at the node 300 when the first switch 11 is opened.

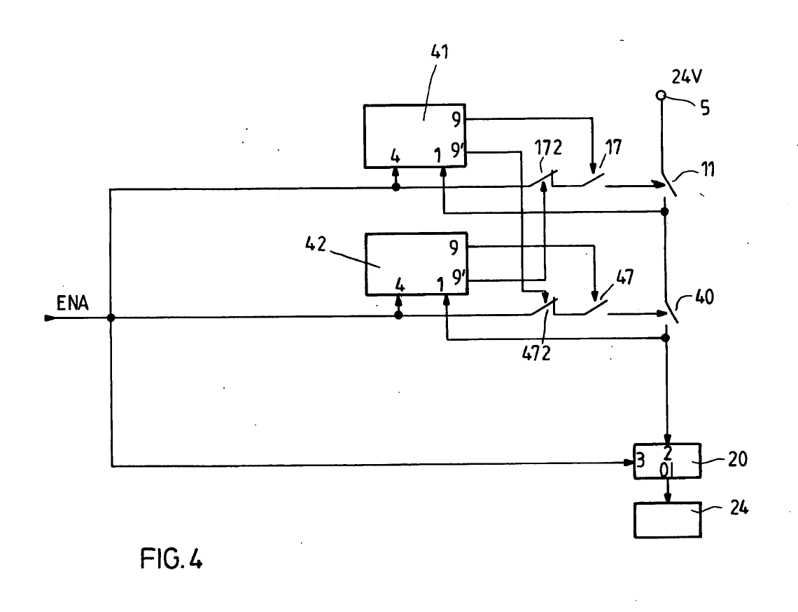

FIG. 4 shows a schematic diagram of the monitoring functions of another embodiment of a hydraulic valve control device 1. The output stage 20 and the hydraulic valve 24 are only shown as blocks in FIG. 4.

A direct voltage of 24 V, in turn, is applied to the voltage supply input 5 of the hydraulic valve control device 1. Two switches are connected in series between the voltage supply input 5 of the hydraulic valve control device 1 and the first voltage supply input 2 of the first output stage 20. In addition to the first switch 11, the redundancy switch 40 is connected in series in such a way that, when at least one of the two switches 11 and 40 opens, the coupling between the voltage supply input 5 of the hydraulic valve control device 1 and the first voltage supply input 2 of the output stage 20 is interrupted. The redundancy switch 40 is provided in order to ensure that the separation from the supply voltage functions even if the first switch 11 fails. The redundancy switch 40 and the appertaining logic serve to meet the safety requirements corresponding to Category 3 of standard EN954-1 or EN13849-1.

In order to actuate the first switch 11 and the redundancy switch 40, the hydraulic valve control device 1 has a first switch-off logic 41, a second switch-off logic 42, the third switch 17, a fifth switch 172, a sixth switch 47 and a seventh switch 472. The enable signal ENA is coupled to the switching input of the first switch 11 via the series connection of the fifth switch 172 and the third switch 17. Moreover, the enable input ENA is coupled to the control input of the redundancy switch 40 via the series connection of the seventh switch 472 and the sixth switch 47.

The control inputs of the third switch 17, of the fifth switch 172, of the sixth switch 47 and of the seventh switch 472 are actuated by the switch-off logics 41 and 42. The control logics 41 and 42 are constructed identically to the monitoring block 19, whereby an input 9′ is additionally provided that serves to switch off another switch. The output 9 serves to switch off the third switch 17 when the output stage is not enabled and in order to check the first switch 17 by means of the signal emitted by the oscillator 30.

If an error is ascertained in the functionality of the first switch 11, the first switch 11 is opened via the output 9 of the switch-off logic 41 and the third switch 17. In addition, the output 9′ is operated in such a manner that the seventh switch 472 is also opened. As a result, the redundancy switch 40 is opened so that the additional redundancy switch 40 ensures that no more current is flowing into the output stage 20. If the checking procedure ascertains that the first switch 11 has not switched correctly, there is a considerable risk that the switching-off by means of the third switch 17 will likewise be unsuccessful and that the voltage supply will not be interrupted. This is why the redundancy switch 40 is provided, which ensures a reliable switching-off.

The switch-off logic 42 functions in an analogous manner; via its input 1, it monitors the redundancy switch 40 and, at the output 9, emits the pulsed signal provided by the oscillator 30 and, in the case of an error, switches off not only the sixth switch 47 but also the fifth switch 172. Owing to their crossed switching-off, the two switch-off logics 41 and 42 ensure a higher level of safety for disconnecting the output stage from the supply circuit.

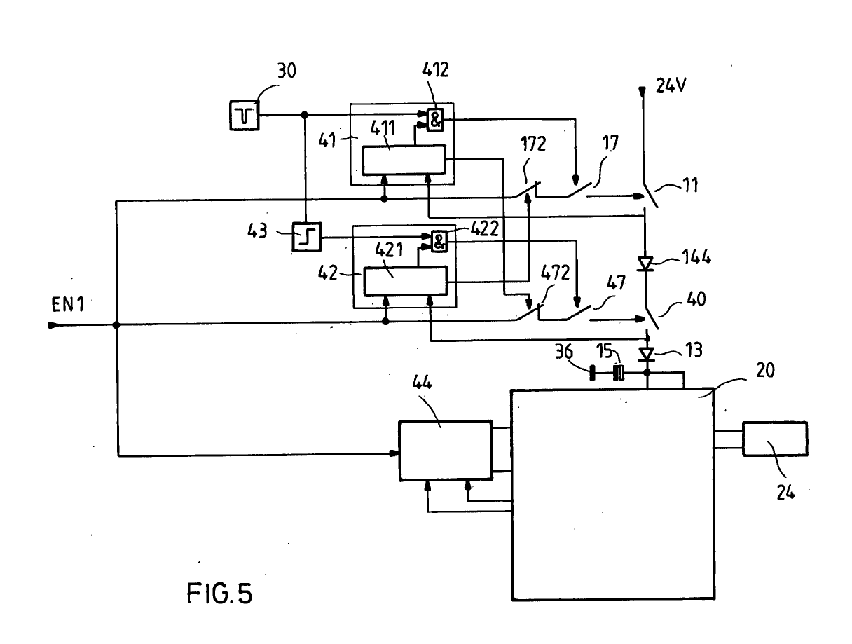

FIG. 5 shows additional details of the switching-off shown in FIG. 4. Like in FIG. 1, the first diode 13 and the first capacitor 15 are also provided. Moreover, another diode 144 located between the first switch 11 and the redundancy switch 40 is connected in series to these two switches 11 and 40.

The output stage 20 comprises a full bridge that receives its control signals from the current regulator 44 that regulates the full bridge on the basis of a measured value for the current that flows through the solenoid. The current regulator can be implemented as an analog circuit, as a digital circuit on its own or in a microcontrol device.

The switch-off devices 41 and 42 each have an error recognition unit 411 and 421 as well as an AND gate 412 and 422. The error recognition unit 411 emits a low level to the AND gate 412 when an error is discovered. The AND gate 412 receives the output signal of the oscillator 30 as the second input signal and, with its output, actuates the third switch 17. A time-delay member 43 is connected between the output of the oscillator and the AND gate 442, and this time-delay element 43 ensures that the switches 11 and 40 are not switched off at the same time.

What is claimed is:

1. A hydraulic valve control device for a hydraulic valve containing at least one actuator, the hydraulic valve control device comprising:
a first voltage supply input;
an output stage configured to output a drive current for driving the actuator, wherein the output stage has a second voltage supply input;
a first switch disposed between the first voltage supply input and the second voltage supply input;
an enable input configured to switch the output stage between an on position and an off position;
a switch-off device configured to open the first switch when the output stage is in the off position; and
a checking circuit configured to check a function of the first switch when the output stage is in the on position.

2. The hydraulic valve control device as recited in claim 1, wherein the checking circuit is configured to open the first switch when the output stage is in the on position.

3. The hydraulic valve control device as recited in claim 2, further comprising a measuring circuit configured to detect whether the checking circuit has opened the first switch.

4. The hydraulic valve control device as recited in claim 3, wherein the checking circuit is configured so as to open the first switch during a time t, wherein t<1 ms.

5. The hydraulic valve control device as recited in claim 1, wherein the hydraulic valve control device is disposed in a housing with the hydraulic valve.

6. The hydraulic valve control device as recited in claim 1, further comprising an uncoupling device so as to uncouple the first switch from the second voltage supply input.

7. The hydraulic valve control device as recited in claim 6, wherein the uncoupling device includes a diode.

8. The hydraulic valve control device as recited in claim 1, wherein the measuring circuit includes an error output connected to an output of the hydraulic valve control device.

9. The hydraulic valve control device as recited in claim 1, further comprising a redundancy switch disposed in a path between the first voltage supply input and the second voltage supply input and connected in series to the first switch, and further comprising a safety shutdown configured to open the redundancy switch if the checking circuit does not open the first switch.

10. The hydraulic valve control device as recited in claim 9, further comprising a second checking circuit configured to open the redundancy switch when the output stage is in the on position and a second measuring circuit configured to check whether the second checking circuit has opened the redundancy switch.

11. The hydraulic valve control device as recited in claim 10, further comprising a capacitor configured to stabilize a voltage at the second voltage supply input.

12. The hydraulic valve control device as recited in claim 8, wherein the checking circuit includes an oscillator configured to periodically switch off the first switch.

13. The hydraulic valve control device as recited in claim 1, wherein the measuring circuit includes a resistor disposed between a first terminal of the first switch and a ground.

14. The hydraulic valve control device as recited in claim 1, wherein the first switch includes a power transistor.

15. A method for checking the switch-off function of a hydraulic valve control device comprising:
providing a first voltage supply input;
outputting a drive current for driving the actuator using an output stage, wherein the output stage has a second voltage supply input, a first switch disposed between the first voltage supply input and the second voltage supply input;
switching the output stage between an on position and an off position using an enable input;
opening the first switch using a switch-off device when the output stage is in the off position;
checking the functioning of the first switch when the output stage is in the on position using a checking circuit; and
checking whether the first switch was opened.
